(19) United States
(12) Patent Application Publication
(10) Pub. No.: US 2012/0092215 A1
(43) Pub. Date: Apr. 19, 2012

(54) SYSTEMS AND METHODS FOR OBTAINING A POSITION OF A CARGO CONTAINER

(76) Inventor: YAT WAI EDWIN KWONG, Hong Kong (CN)

(21) Appl. No.: 12/904,040

(22) Filed: Oct. 13, 2010

(51) Int. Cl. G01S 19/12

(52) U.S. Cl. 342/357.49

(57) ABSTRACT

Systems and methods are provided for real-time data notification. In accordance with one implementation, a computerized method is provided that includes defining an event related to a resource in accordance with input from a first subscriber, and allowing a second subscriber to subscribe to a message concerning the event defined by the first subscriber. The method also includes receiving data generated by a reporter module, the reporter module being configured to monitor at least one attribute of the resource, and interpreting the data generated by the reporter module to determine the occurrence of the event defined by the first subscriber. In addition, the method includes delivering, when it is determined that the event has occurred, a message to the first subscriber, the message including content concerning the event. Additionally, the message concerning the event may be delivered to the second subscriber.

### BACKGROUND

I. Technical Field

The present invention generally relates to the field of obtaining positions of cargo containers. Specifically, and without limitation, the invention relates to systems and methods that obtain positions of cargo containers using lead edge technologies, such as GPS (Global Positioning System).

II. Background Information

Having a reliable and efficient system to track containers is desirable and is a long-felt need in the cargo, flight, and shipping industry. Usually, a container is not fixed in a particular location. Instead, a container may be found in a plurality of places. A container may be located in a warehouse, a shipping area, or even on a shipping vessel. A container may also be placed in a delivery truck waiting to be dispatched. Sometimes, a container may be in a local neighborhood. In other times, a container may be placed a highly remote area. One issue concerning existing systems to track containers is the lack of reliability to keep track a container when the container is in a remote area where coverage of communication is extremely limited. In that case, a monitoring party wishing to communicate with the detecting device attached in a monitored container cannot be achieved, as the strength of the receiving signal by the detecting device is weakened, due to the limited coverage in the remote area. Besides, even in an area where signal is receivable, a second issue arises when a container is stacked up by multiple containers from the top. In that case, the detecting device used to detect signals from the monitoring system can fail to function properly. Additionally, a third issue arises, as a monitored container, and its associated detecting device, is susceptible to physical damages. Containers are frequently lifted by heavy duty machines. When one container is moved from one location to another, any equipments attached to the container is highly susceptible to physical damages. Additionally, as mentioned previously, containers may be stacked up by multiple containers. Therefore, in these cases, protective features should be carefully designed.

In view of the foregoing, there is a need for systems and methods that monitor cargo containers in an efficient manner. There is also a need for systems and methods that can reliably monitor containers that are situate in remote areas where coverage of communication is extremely limited. In addition, there is a need for a solution that permits monitoring when a container is stacked up by multiple containers from the top.

### SUMMARY

Embodiments of the present invention relate to systems and methods for positioning cargo containers. Certain embodiments of the invention include a main device. The main device may be defined as a device attached to a top part of the container. In one embodiment, the main device receives GPS signal from the GPS satellite to determine location of the container. The main device sends a signal including the location to a communication satellite. The communication satellite may send the signal to the land earth station, which allows a satellite service provider to determine the location of the container based on the signal sent from the communication satellite.

Consistent with certain embodiments of the invention, the present invention includes a data communication system for positioning cargo containers. The system includes a first repeater, a second repeater, a third repeater, and a main device. The first repeater may be attached to a first side of a first container, whereas the second repeater attached to a second side of the first container. Likewise, the third repeater may be attached to a third side of the first container, and the main device may be attached to a top part of the first container, including a number of non-limiting components, such as a CPU, a GPS module, and a battery. In one embodiment, the first container may be stacked up by a second container. When this occurs, the main device may wake up automatically according to a schedule determined by a timer included in the main device. When the main device fails an attempt to receive a GPS signal from a GPS satellite and fails an attempt to receive a GPRS signal from a cellular tower, the main device wakes up the first, second, and third repeaters from sleep mode. The main device may then determine a location of the first container. The first repeater may send a signal including the location to a communication satellite. Afterwards, the communication satellite may send the signal to the land earth station. In addition, a land earth station may allow a satellite service provider to determine the location of the first container based on the signal sent from the communication satellite.

In accordance with an embodiment of the present invention, wherein after the first, second, and third repeaters have woken up from the sleep mode, each of the second and third repeaters may receive a GPS signal from the GPS satellite before a GPS timeout period determined in the main device expires. The strength of each GPS signal received by the first, second, and third repeaters may be varied in view of location of each repeater. In this embodiment, the first repeater may be failed to receive a GPS signal from the GPS satellite. In such a case, the main device may be configured to receive the GPS signal that the second and third repeaters have received from the GPS satellite.

In an alternative embodiment, the inventive system, wherein after the first, second, and third repeaters have woken up from the sleep mode, each of the first and second repeaters fails to receives a GPS signal from the GPS satellite, for the signal is blocked by the third and fourth containers. The third repeater, whose signal is receivable without being blocked by the third and fourth containers, receives a GPS signal from the GPS satellite. At this point, the main device may receive the GPS signal from the third repeater. The main device then determines the location of the first container, based on the GPS signal received from the third repeater.

In yet another embodiment, the first repeater may be located inside a trench on the first side of the first container to prevent the first repeater from being hit by physical objects. The second repeater may be placed in a protective container to prevent the second repeater from being hit by physical objects and is made by a material that permits transmission of GPS and GPRS signals without causing signal degradation. The third repeater may have a color identical to the third side of the first container, and is located inside a trench on the third side of the first container to prevent the first repeater from being found.

In another embodiment, the first repeater may include a battery unit, a GPS antenna for receiving GPS signals, a GPS repeater for repeating GPS signals, a satellite antenna for communicating with the communication satellite, and a satellite signal repeater for repeating satellite signals, wherein the first repeater is located inside a trench on the first side of the first container to prevent the first repeater from being hit by physical objects.

In accordance with an embodiment of the present invention, the present invention includes a computer-implemented method for positioning cargo containers. The method includes waking up a main device according to a schedule determined by a timer included in the main device, wherein the main device is attached to a top part of a first container, includes a CPU, a GPS module, and a battery, the first container being stacked up by a second container. Further, the method includes waking up, by the main device, a first, second, and third repeaters from sleep mode, when the main device fails an attempt to receive a GPS signal from a GPS satellite and fails an attempt to receive a GPRS signal from a cellular tower, wherein the first repeater is attached to a first side of a first container, the second repeater is attached to a second side of the first container, and the third repeater is attached to a third side of the first container. Additionally, the method includes determining, by the main device, a location of the first container; sending, by the first repeater, a signal including the location to a communication satellite; sending, the communication satellite, the signal to the land earth station; and allowing, a land earth station, a satellite service provider to determine the location of the first container based on the signal sent from the communication satellite.

It is to be understood that both the foregoing general description and the following detailed description are exemplary and explanatory only, and are not restrictive of the scope of the invention, described and as claimed. Furthermore, features and variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram illustrating an exemplary system, consistent with an embodiment of the present invention.

### DETAILED DESCRIPTION

Embodiments of the present invention relate to systems and methods for positioning cargo containers. Certain embodiments of the invention include a main device. The main device may be defined as a device attached to a top part of the container. In one embodiment, the main device receives GPS signal from the GPS satellite to determine location of the container. The main device sends a signal including the location to a communication satellite. The communication satellite may send the signal to the land earth station, which allows a satellite service provider to determine the location of the container based on the signal sent from the communication satellite.

Reference will now be made in detail to the present exemplary embodiments of the invention, examples of which are illustrated in the accompanying drawings. Wherever possible, the same reference numbers will be used throughout the drawings to refer to the same or like parts.

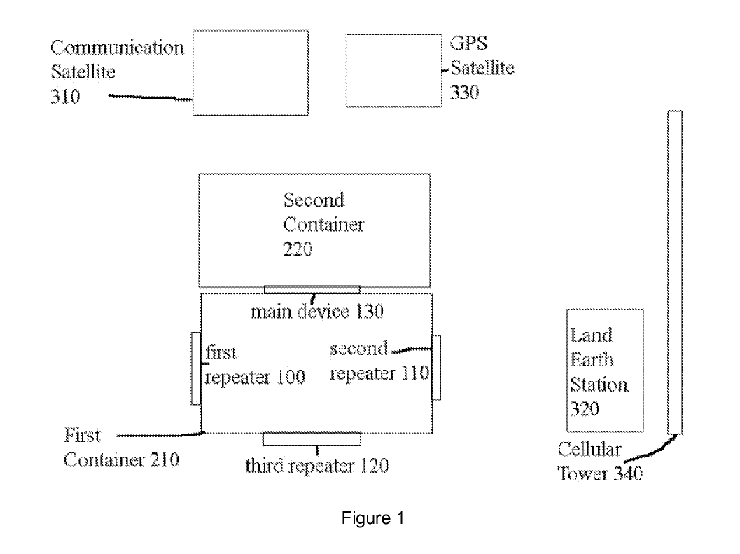

FIG. 1. Shows an exemplary system that includes a first repeater 100, a second repeater 110, a third repeater 120, and a main device 130. The first repeater 100 may be attached to a first side of a first container 210, whereas the second repeater 220 attached to a second side of the first container 210. Likewise, the third repeater 120 may be attached to a third side of the first container 210, and the main device 130 may be attached to a top part of the first container 210, including a number of non-limiting components, such as a CPU, a GPS module, and a battery. In one embodiment, the first container 210 may be stacked up by a second container 220. When this occurs, the main device 130 may wake up automatically according to a schedule determined by a timer included in the main device 130. When the main device 130 fails an attempt to receive a GPS signal from a GPS satellite 330 and fails an attempt to receive a GPRS signal from a cellular tower 340, the main device 130 wakes up the first repeater 100, the second repeater 110, and third repeater 120 from sleep mode. The main device 130 may then determine a location of the first container 210. The first repeater 100 may send a signal including the location to a communication satellite 310. Afterwards, the communication satellite 310 may send the signal to the land earth station 320. In addition, a land earth station 320 may allow a satellite service provider to determine the location of the first container 210 based on the signal sent from the communication satellite 310.

In accordance with an embodiment of the present invention, wherein after the main device 130, the first repeater 100, the second repeater 110, and the third repeater 120 have woken up from the sleep mode, each of the second repeater 110 and the third repeater 120 may receive a GPS signal from the GPS satellite 330 before a GPS timeout period determined in the main device 130 expires. The strength of each GPS signal received by the first repeater 100, the second repeater 110, and the third repeater 120 may be varied in view of location of each repeater. In this embodiment, the first repeater 100 may be failed to receive a GPS signal from the GPS satellite 330. In such a case, the main device 130 may be configured to receive the GPS signal that the second repeater 110 and the third repeater 120 have received from the GPS satellite 330.

In an alternative embodiment, the inventive system, wherein after the main device 130, the first repeater 100, the second repeater 110, and the third repeater 120 have woken up from the sleep mode, each of the first and second repeaters fails to receives a GPS signal from the GPS satellite 330, for the signal is blocked by the third and fourth containers. The third repeater, whose signal is receivable without being blocked by the third and fourth containers, receives a GPS signal from the GPS satellite 330. At this point, the main device 130 may receive the GPS signal from the third repeater. The main device 130 then determines the location of the first container 210, based on the GPS signal received from the third repeater.

In yet another embodiment, the first repeater 100 may be located inside a trench on the first side of the first container 210 to prevent the first repeater 100 from being hit by physical objects. The second repeater 110 may be placed in a protective container to prevent the second repeater 110 from being hit by physical objects and is made by a material that permits transmission of GPS and GPRS signals without causing signal degradation. The third repeater may have a color identical to the third side of the first container 210, and is located inside a trench on the third side of the first container 210 to prevent the first repeater 100 from being found.

In another embodiment, the first repeater 100 may include a battery unit, a GPS antenna for receiving GPS signals, a GPS repeater for repeating GPS signals, a satellite antenna for communicating with the communication satellite 310, and a satellite signal repeater for repeating satellite signals, wherein the first repeater 100 is located inside a trench on the first side of the first container 210 to prevent the first repeater 100 from being hit by physical objects.

The present invention may be implemented as a computer-implemented method. The present invention, when implemented as a computer-implemented method, includes a computer-implemented method for positioning cargo containers. The method includes waking up a main device 130 according to a schedule determined by a timer included in the main device 130, wherein the main device 130 is attached to a top part of a first container 210, includes a CPU, a GPS module, and a battery, the first container 210 being stacked up by a second container 220. Further, the method includes waking up, by the main device 130, a first, second, and third repeaters from sleep mode, when the main device 130 fails an attempt to receive a GPS signal from a GPS satellite 330 and fails an attempt to receive a GPRS signal from a cellular tower 340, wherein the first repeater 100 is attached to a first side of a first container 210, the second repeater 110 is attached to a second side of the first container 210, and the third repeater is attached to a third side of the first container 210. Additionally, the method includes determining, by the main device 130, a location of the first container 210; sending, by the first repeater 100, a signal including the location to a communication satellite 310; sending, the communication satellite 310, the signal to the land earth station 320; and allowing, a land earth station 320, a satellite service provider to determine the location of the first container 210 based on the signal sent from the communication satellite 310.

The main device 130 may be configured to further support the first, second, and third repeaters. As an example, wherein after the first, second, and third repeaters have woken up from the sleep mode, further comprises receiving, by each of the second and third repeaters, a GPS signal from the GPS satellite 330 before a GPS timeout period determined in the main device 130 expires, wherein strength of each GPS signal received by the first, second, and third repeaters varies in view of location of each repeater; the first repeater 100 fails to receive a GPS signal from the GPS satellite 330; and the main device 130 receives the GPS signal that the second and third repeaters have received from the GPS satellite 330.

Alternatively, the main device 130 may be configured in that wherein after the first, second, and third repeaters have woken up from the sleep mode, each of the first and second repeaters fails to receives a GPS signal from the GPS satellite 330, for the signal is blocked by the third and fourth containers; the third repeater 120, whose signal is receivable without being blocked by the third and fourth containers, receives a GPS signal from the GPS satellite 330; the main device 130 receives the GPS signal from the third repeater 120; and the main device 130 determines the location of the first container 210, based on the GPS signal received from the third repeater 120.

As another example, the main device 130 may be configured in that the first repeater 100 is located inside a trench on the first side of the first container 210 to prevent the first repeater 100 from being hit by physical objects.

In accordance with an embodiment of the invention, a data communication system may be implemented for positioning containers, comprising a GPS satellite 330, a cellular tower 340, a communication satellite 310, a land earth station 320, and a main device 130 attached to a top part of a first container 210, wherein the first container 210 is being stacked up by a second container 220; after the main device 130 failing to receive a GPS signal from the GPS satellite 330, the main device 130 receives a GPRS signal from the cellular tower 340 to determine location of the container, the main device 130 sends a signal including the location to the communication satellite 310; the communication satellite 310 sends the signal including the location to the communication satellite 310 to the land earth station 320; and the land earth station 320 allows a satellite service provider to determine the location of the container based on the signal sent from the communication satellite 310.

Another embodiment that is consistent with the present invention includes configuring the main device 130, such that the main device 130 is attached to a top part of the first container 210, wherein the first container 210 is being stacked up by a second container 220; after the main device 130 failing to receive a GPS signal from the GPS satellite 330 and failing to receive a GPRS signal from the cellular tower 340, the repeater receives the GPS signal from the GPS satellite 330 to determine location of the container; the repeater sends a signal including the location to the communication satellite 310; the communication satellite 310 sends the signal to the land earth station 320; and the land earth station 320 allows a satellite service provider to determine the location of the container based on the signal sent from the communication satellite 310.

In yet another embodiment, the present invention includes configuring the main device 130, such that the first container 210 is being stacked up by a second container 220; the main device 130 wakes up from sleep mode using the CPU and power from the battery, according to a schedule determined by a timer included in the main device 130; after the main device 130 failing an attempt to receive a GPS signal from the GPS satellite 330 and failing an attempt to receive a GPRS signal from the cellular tower 340, the main device 130 wakes up the repeater from sleep mode; the repeater receives the GPS signal from the GPS satellite 330 to determine location of the container, using the GPS module included in the main device 130; the repeater sends a signal including the location to the communication satellite 310; the communication satellite 310 sends the signal to the land earth station 320; and the land earth station 320 allows a satellite service provider to determine the location of the container based on the signal sent from the communication satellite 310.

The present techniques and embodiments described herein, including the exemplary systems and methods presented above, can be implemented in digital electronic circuitry, or in computer hardware, firmware, software, or in any suitable combinations thereof. In addition, apparatus and systems consistent with the present invention can be implemented in a computer program product tangibly embodied in a machine-readable storage device for execution by a programmable processor.

Method steps according to embodiments of the invention can be performed by a programmable processor executing a program of instructions to perform functions or steps of the methods by operating based on input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, or in assembly or machine code. The language or code can be a compiled or interpreted language or code. Processors may include general and special purpose microprocessors. A processor receives instructions and data from memories, in particular from read-only memories or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in application-specific integrated circuits (ASICs).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Although illustrative embodiments have been described herein with reference to the accompanying drawings, it is noted that the invention is not limited to the precise system and method embodiments described herein, and that various other changes and modifications may be affected by one skilled in the art without departing from the scope or spirit of the invention. All such changes and modifications are intended to be included within the scope of the invention as defined by the appended claims.

What is claimed is:

1. A data communication system for positioning containers, comprising:
a first repeater that is attached to a first side of a first container;
a second repeater attached to a second side of the first container;
a third repeater attached to a third side of the first container; and
a main device, which is attached to a top part of the first container, includes a CPU, a GPS module, and a battery, wherein
the first container is being stacked up by a second container;
the main device wakes up automatically according to a schedule determined by a timer included in the main device;
when the main device fails an attempt to receive a GPS signal from a GPS satellite and fails an attempt to receive a GPRS signal from a cellular tower, the main device wakes up the first, second, and third repeaters from sleep mode;
the main device determines a location of the first container;
the first repeater sends a signal including the location to a communication satellite;
the communication satellite sends the signal to the land earth station; and
a land earth station allows a satellite service provider to determine the location of the first container based on the signal sent from the communication satellite.

2. The system of claim 1, wherein after the main first, second, and third repeaters have woken up from the sleep mode,
each of the second and third repeaters receives a GPS signal from the GPS satellite before a GPS timeout period determined in the main device expires;
strength of each GPS signal received by the first, second, and third repeaters varies in view of location of each repeater;
the first repeater fails to receive a GPS signal from the GPS satellite; and
the main device receives the GPS signal that the second and third repeaters have received from the GPS satellite.

3. The system of claim 1, wherein after the main first, second, and third repeaters have woken up from the sleep mode,
each of the first and second repeaters fails to receives a GPS signal from the GPS satellite, for the signal is blocked by the third and fourth containers;
the third repeater, whose signal is receivable without being blocked by the third and fourth containers, receives a GPS signal from the GPS satellite;
the main device receives the GPS signal from the third repeater; and
the main device determines the location of the first container, based on the GPS signal received from the third repeater.

4. The system of claim 3, wherein the first repeater is located inside a trench on the first side of the first container to prevent the first repeater from being hit by physical objects.

5. The system of claim 3, wherein the second repeater is placed in a protective container to prevent the second repeater from being hit by physical objects and is made by a material that permits transmission of GPS and GPRS signals without causing signal degradation.

6. The system of claim 3, wherein the third repeater has a color identical to the third side of the first container, is located inside a trench on the third side of the first container to prevent the first repeater from being found.

7. The system of claim 3, wherein the first repeater includes a battery unit, a GPS antenna for receiving GPS signals, a GPS repeater for repeating GPS signals, a satellite antenna for communicating with the communication satellite, and a satellite signal repeater for repeating satellite signals, wherein the first repeater is located inside a trench on the first side of the first container to prevent the first repeater from being hit by physical objects.

8. A computerized method for positioning containers, comprising:
waking up a main device according to a schedule determined by a timer included in the main device, wherein the main device is attached to a top part of a first container, includes a CPU, a GPS module, and a battery, the first container being stacked up by a second container;
waking up, by the main device, a first, second, and third repeaters from sleep mode, when the main device fails an attempt to receive a GPS signal from a GPS satellite and fails an attempt to receive a GPRS signal from a cellular tower, wherein the first repeater is attached to a first side of a first container, the second repeater is attached to a second side of the first container, and the third repeater is attached to a third side of the first container;
determining, by the main device, a location of the first container;
sending, by the first repeater, a signal including the location to a communication satellite;
sending, the communication satellite, the signal to the land earth station; and
allowing, a land earth station, a satellite service provider to determine the location of the first container based on the signal sent from the communication satellite.

9. The method of claim 8, wherein after the main first, second, and third repeaters have woken up from the sleep mode, further comprises:
receiving, by each of the second and third repeaters, a GPS signal from the GPS satellite before a GPS timeout period determined in the main device expires, wherein:
strength of each GPS signal received by the first, second, and third repeaters varies in view of location of each repeater;
the first repeater fails to receive a GPS signal from the GPS satellite; and
the main device receives the GPS signal that the second and third repeaters have received from the GPS satellite.

10. The method of claim 8, wherein after the main first, second, and third repeaters have woken up from the sleep mode:
each of the first and second repeaters fails to receives a GPS signal from the GPS satellite, for the signal is blocked by the third and fourth containers;
the third repeater, whose signal is receivable without being blocked by the third and fourth containers, receives a GPS signal from the GPS satellite;
the main device receives the GPS signal from the third repeater; and
the main device determines the location of the first container, based on the GPS signal received from the third repeater.

11. The method of claim 8, wherein the first repeater is located inside a trench on the first side of the first container to prevent the first repeater from being hit by physical objects.

12. A system for positioning containers, comprising:
a processor; and
a memory storing executable instructions causing the processor to execute a set of methods, the method comprises:
waking up a main device according to a schedule determined by a timer included in the main device, wherein the main device is attached to a top part of a first container, includes a CPU, a GPS module, and a battery, the first container being stacked up by a second container;
waking up, by the main device, a first, second, and third repeaters from sleep mode, when the main device fails an attempt to receive a GPS signal from a GPS satellite and fails an attempt to receive a GPRS signal from a cellular tower, wherein the first repeater is attached to a first side of a first container, the second repeater is attached to a second side of the first container, and the third repeater is attached to a third side of the first container;
determining, by the main device, a location of the first container;
sending, by the first repeater, a signal including the location to a communication satellite;
sending, the communication satellite, the signal to the land earth station; and
allowing, a land earth station, a satellite service provider to determine the location of the first container based on the signal sent from the communication satellite.

13. The system of claim 12, wherein after the main first, second, and third repeaters have woken up from the sleep mode, further comprises:
receiving, by each of the second and third repeaters, a GPS signal from the GPS satellite before a GPS timeout period determined in the main device expires, wherein:
strength of each GPS signal received by the first, second, and third repeaters varies in view of location of each repeater;
the first repeater fails to receive a GPS signal from the GPS satellite; and
the main device receives the GPS signal that the second and third repeaters have received from the GPS satellite.

14. The system of claim 12, wherein after the main first, second, and third repeaters have woken up from the sleep mode:
each of the first and second repeaters fails to receives a GPS signal from the GPS satellite, for the signal is blocked by the third and fourth containers;
the third repeater, whose signal is receivable without being blocked by the third and fourth containers, receives a GPS signal from the GPS satellite;
the main device receives the GPS signal from the third repeater; and
the main device determines the location of the first container, based on the GPS signal received from the third repeater.

15. The system of claim 12, wherein the first repeater is located inside a trench on the first side of the first container to prevent the first repeater from being hit by physical objects.

16. The system of claim 12, wherein the second repeater is placed in a protective container to prevent the second repeater from being hit by physical objects and is made by a material that permits transmission of GPS and GPRS signals without causing signal degradation.

17. The system of claim 12, wherein the third repeater has a color identical to the third side of the first container, is located inside a trench on the third side of the first container to prevent the first repeater from being found.

18. The system of claim 12, wherein the first repeater includes a battery unit, a GPS antenna for receiving GPS signals, a GPS repeater for repeating GPS signals, a satellite antenna for communicating with the communication satellite, and a satellite signal repeater for repeating satellite signals, wherein the first repeater is located inside a trench on the first side of the first container to prevent the first repeater from being hit by physical objects.
